(19) United States
(12) Patent Application Publication
(10) Pub. No.: US 2003/0220832 A1
(43) Pub. Date: Nov. 27, 2003

(54) Method and facility for providing limousine services

(76) Inventor: Paul Panos, Melville, NY (US)

Correspondence Address: FITZPATRICK CELLA HARPER & SCINTO, 30 ROCKEFELLER PLAZA, NEW YORK, NY, 10112, US

(21) Appl. No.: 10/154,525

(22) Filed: May 23, 2002

(51) Int. Cl. G06F 17/60

(52) U.S. Cl. 705/13

(57) ABSTRACT

A limousine drivers' facility, which is located in the vicinity of an airport, comprises parking areas 14 and a lounge area 16, which includes a drivers' lounge 28 having a display 30 which provides updated flight information to drivers. An adjacent passenger lounge area 30 is also disclosed and the two lounge areas may include amenities such as bookings reservations, food and entertainment.

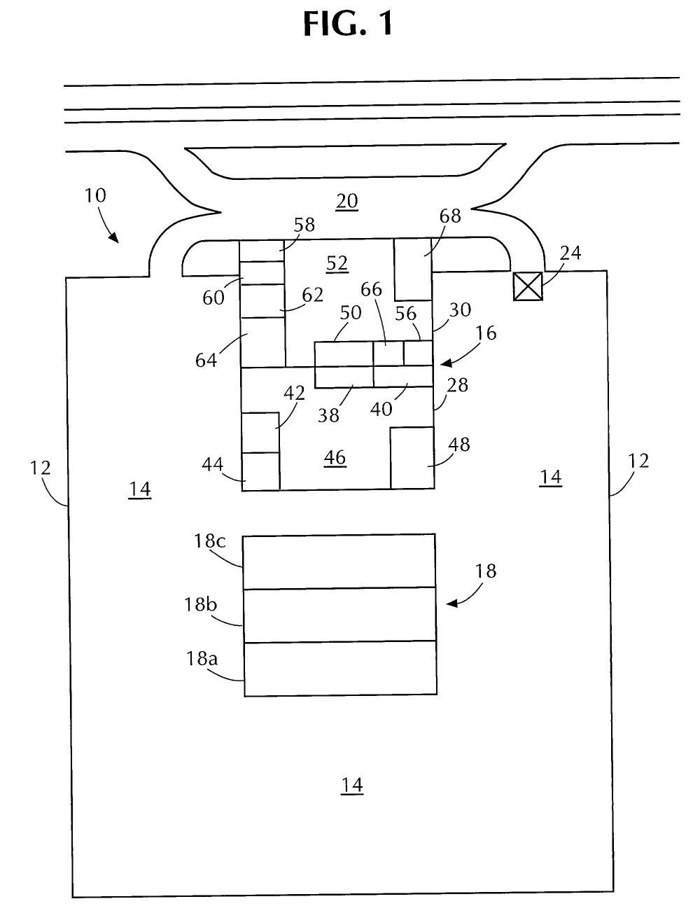

### BACKGROUND OF THE INVENTION

1. Field of the Invention

This invention relates to limousine services and facilities for providing such services. More particularly, the invention concerns a novel method of providing services to limousine drivers and a novel facility at which the services are provided.

2. Description of the Related Art

Many systems and facilities have been developed to assist the traveling public. For example WO 98/18096 discloses an automated computerized ground transportation system which links vendors of ground transportation services and agents selling such services. U.S. Pat. No. 3,916,588 discloses an airport complex for facilitating the movement of passengers and cargo and includes a portion of a terminal building roof surrounding a hotel building that affords vehicle parking, car rental, heliport and other facilities. U.S. Pat. No. 6,115,974 discloses an integrated entertainment and resort complex with transportation hubs, a shopping mall and a waterway with barges. U.S. Pat. No. 6,308,160 discloses a method and system for operating an indoor golf facility in the operations of airport terminals, airlines and goods and service providers, together with a computer system having links to travel agents, airline flight scheduling databases, etc. U.S. Pat. No. 5,953,706 discloses a transportation network system which integrates communications and data transmission requirements for ground transportation service providers into a single, centrally controlled network.

In addition, U.S. Pat. No. 6,065,511 discloses a system for refueling trucks and providing a driver respite area allowing the driver to park his vehicle, sleep, shower or have his vehicle washed or repaired.

However, no system has been developed which provides limousine drivers who transport passengers to and from airports with the ability to obtain updated flight and booking information while their vehicles are parked in close proximity to an airport passenger terminal. Further, because of security concerns, limousines are usually not allowed to be parked close to airport terminals and the drivers are often forced to find available waiting space on streets which may be quite far from the airport terminal. While limousine drivers are usually allowed to park in the airport's parking lot, the fees for such parking are usually quite high, and the drivers have no access to flight information unless they leave the vehicle and walk to the passenger terminal.

### SUMMARY OF THE INVENTION

In one aspect, the present invention provides limousine drivers continuous access to updated flight and booking information without the need to travel to their respective dispatch centers. According to this aspect, the present invention involves the steps of providing a limousine parking facility in the vicinity of an airport, providing a drivers' lounge at the parking facility, displaying at the lounge, updated flight information from the airport, and providing to drivers at the lounge, information regarding requests for limousine services. The term “limousine” herein refers to any passenger carrying vehicle which is used to provide transportation services to passengers by way of advanced reservation, for example by telephone.

According to another aspect of the invention, there is provided a limousine drivers' facility which comprises a limousine parking facility in the vicinity of an airport, a limousine drivers' lounge at the parking facility, a display, at the drivers' lounge, of updated flight information from the airport; and an information facility at the driver's lounge for providing, to limousine drivers at the limousine drivers' lounge, information regarding requests for limousine services.

The invention makes it possible for limousine drivers both to park their vehicles at a location which allows for quick travel to and from an airport passenger terminal, and at the same time to obtain updated flight and booking information. In this way, driver stress is relieved and compatibility between the times of arrival of air passengers and limousines at the passenger terminal is assured.

### BRIEF DESCRIPTION OF THE DRAWING

The sole FIGURE is a diagrammatic representation of a limousine drivers' facility in which the present invention is embodied

### DETAILED DESCRIPTION OF THE PREFERRED EMBODIMENT

As shown in the drawing, a limousine facility 10 is enclosed by a fence or wall 12. The facility 10 is located in the vicinity of an airport terminal (not shown), that is, separate from the airport's public parking area but within a distance which will allow a limousine to reach the airport's passenger terminal within five or ten minutes. Located within the facility 10 are limousine parking areas 14, a lounge 16 and limousine service areas 18, such as a refueling station 18a, a car wash station 18b and an oil change/repair station 18c.

The facility 10 is provided with a passenger pick up and drop off area 20 in front of the lounge 16 where passengers going to and coming from the airport can be picked up or dropped off. Beyond the pick up and drop off area 20 is a limousine entrance 22 which is provided with a user check station and gate 24 for controlling access to the facility. The user check station operates to verify whether an approaching vehicle is authorized to use the facility. If the vehicle is authorized, the gate is opened to give the vehicle access to the facility. The user check station and gate 24 may be provided with an electronic sensor which reads a coded label on the vehicle; or the check station may be provided with a guard who checks a pass carried by the driver or the vehicle. In either case, the gate is opened when the authorization of the vehicle is assured.

Once a vehicle has passed through the user check station and gate 24, it may proceed to one of the parking areas 14. The driver may leave the vehicle in the parking area and proceed to the lounge 16. In addition the driver may have the vehicle refueled or washed at refueling station 18a or the car wash station 18b. Also, if an oil change or repairs are necessary, the driver may have this done at the oil change/repair station 18c. The driver may then return the vehicle the parking area 14 and go to the lounge 16. Alternatively, the driver may proceed to the pick up and drop off area 20 to pick up a passenger or passengers; or the driver may leave the facility 10 and proceed to the airport or to the city or region serviced by the airport.

In the present embodiment, the lounge 16 is divided into a drivers' lounge 28 which faces the parking and limousine services areas 14, 18a, 18b and 18c, and an executive or passengers' lounge 30 which faces the pickup and drop off area 20.

The overall arrangement of the drivers lounge 28 and the executive lounge 30 is shown in the drawing. As can be seen, the drivers' lounge 28 includes a flight information display area 38 where continuous updated flight information, including estimated time of arrivals and departures, and flight cancellations relating to the airport are displayed. There is also provided a booking facility 40 which receives information by telephone or radio and which provides drivers with booking information regarding passengers to be picked up or dropped off at the airport.

The drivers' lounge 28 is also provided with a food court 42, which may include food vending machines, an entertainment/arcade area 44 and a lounge area 46 with television and restrooms. The drivers' lounge may also be provided with a drivers' services area 48 which may provide drivers access to various other services, for example lawyer assistance.

The executive lounge 30, also includes a flight information display area 50, and an executive lounge area 52 with television and restrooms. In addition, the executive lounge 30 may include a food court 54, an Internet service facility 56 a gift shop/news stand 58, a shoe shine stand 60, a dry cleaning/valet service area 62, a fitness center 64 and a reservation facility 66 for making reservations with hotels, restaurants, shows, etc. and limousine services. Also, meeting rooms 68 and secretarial services may be provided in the executive lounge 30.

Charges for use of the parking area 14, the lounge 16 and the vehicle service areas 18a, 18b and 18c may be made to limousine drivers on a daily basis or on an annual membership basis. Also, charges may be made to traveling executives who use the executive lounge 30 and its facilities on a daily or annual membership basis.

It will be appreciated that with the present invention, limousine drivers have ready access to updated flight information without the need to use an airport's parking lot and without need to navigate multiple times through busy airport traffic. Further, scheduling between incoming passengers and limousine arrival times at the airport's passenger terminal is more closely controlled, thus eliminating inconvenient delays.

1. A method of providing limousine services comprising the steps of:
providing a limousine parking facility in the vicinity of an airport;
providing a limousine drivers' lounge at said parking facility;
displaying at said drivers' lounge updated flight information from said airport; and
providing to drivers at said limousine drivers' lounge, information regarding requests for limousine services.

2. A method according to claim 1, further including the provision of limousine service facilities at said parking facility, said limousine service facilities including at least one of a car wash service, a car refueling service and an oil change and car repair service.

3. A method according to one of claims 1 or 2, further including the provision of limousine driver services at said limousine drivers' lounge, said limousine driver services including at least one of lawyers services, limousine booking services, food court services and entertainment services.

4. A method according to claim 3, further including the provision of an executive lounge at said facility, said executive lounge including the display of updated airline flight information from said airport.

5. A method according to claim 4, further including the provision of executive services at said executive lounge, said executive services including at least one of hotel, restaurant and entertainment reservation services, secretarial services, meeting room services, food services, local entertainment services, internet services, facsimile and cell phone rental services, gift shop and newsstand services, dry cleaning and valet services and fitness services.

6. A limousine drivers' facility comprising
a limousine parking facility in the vicinity of an airport,
a limousine drivers' lounge at said parking facility;
a display, at said drivers' lounge, of updated flight information from said airport; and
an information facility at said driver's lounge for providing, to limousine drivers at said limousine drivers' lounge, information regarding requests for limousine services.

7. A limousine drivers' facility according to claims 6, further including, at said parking facility, at least one of a car wash station, a car refueling station and an oil change and car repair station.

8. A limousine drivers' facility according to one of claims 6 or 7, further including limousine driver services facilities at said limousine drivers' lounge, said limousine driver services facilities including at least one of a lawyers service facility, a limousine booking facility, and food court and entertainment facilities.

9. A limousine drivers' facility according to claim 8, further including an executive lounge at said facility, said executive lounge including the display of updated airline flight information from said airport.

10. A limousine drivers' facility according to claim 9 and further including, at said executive lounge, at least one of a hotel, restaurant and entertainment reservation services facility, a secretarial services facility, a meeting room facility, a food service facility, a local entertainment facility, an internet facility, a facsimile and cell phone rental facility, a gift shop and newsstand, a dry cleaning and valet services facility and a fitness facility.
